(19) United States
(12) Patent Application Publication
(10) Pub. No.: US 2003/0050931 A1
(43) Pub. Date: Mar. 13, 2003

(54) System, method and computer program product for page rendering utilizing transcoding

(76) Inventors: Gregory Harman, Cambridge, MA (US); Quinton Y. Zondervan, Boston, MA (US)

Correspondence Address: SILICON VALLEY INTELLECTUAL PROPERTY GROUP, P.O. BOX 721120, SAN JOSE, CA, 95172-1120, US

(21) Appl. No.: 09/942,051

(22) Filed: Aug. 28, 2001

(51) Int. Cl. G06F 7/00

(52) U.S. Cl. 707/100

(57) ABSTRACT

A system, method and computer program product are provided for rendering arbitrary content for display on a particular viewing device. First, content is received. The content is assembled into an object-oriented structure in a centralized format. The content in the centralized format is translated to a markup language compatible with a display environment of a viewing device using a descriptor that defines parameters of the display environment. The markup language is formatted for display on the viewing device. The formatted markup language is output to the viewing device. A system, method and computer program product are also provided for rendering arbitrary content for display on a particular viewing device: Content is received and assembled into a Document Object Model (DOM) tree in a centralized format. The content in the DOM tree is translated to a markup language compatible with a display environment of a viewing device. The markup language is formatted for display on the viewing device. Such formatting includes splitting the markup language into multiple pages for display on the viewing device. The formatted markup language is output to the viewing device. A system, method and computer program product are also provided for dividing content into multiple pages for display on a particular viewing device. Content is received and translated to a markup language compatible with a display environment of a viewing device. The markup language is split into multiple items. The multiple items are parsed into multiple pages. One page of the set of pages is output to the viewing device. The one page has a pointer to at least one of the other pages.

### FIELD OF THE INVENTION

The present invention relates to computer-related transactions, and more particularly to automating computer-related transactions.

### BACKGROUND OF THE INVENTION

The Internet is composed of content distributed in the World Wide Web and various intranets. While a large fraction of the content is static, the truly interesting content is the one that a user can interact with dynamically. This content is of various types including, but not limited to (i) the content stored in various databases, (ii) e-commerce web-pages, (iii) directories, (iv) intranet pages, (v) data warehouses, etc.

The interaction with this dynamic content is accomplished through (i) queries/submissions to databases, (ii) buying/selling/interacting through e-commerce, (iii) running queries and lookups in directories, (iv) accessing and interacting with content resident on intranet pages (including on individual computers), and/or (v) accessing, interacting with, adding, subtracting or modifying content resident in data warehouses.

The access to or interaction with this dynamic content is done in a variety of ways. For example, such interaction may be accomplished through direct access to the databases by running specific commands or through form submissions on the Internet that run specific queries or perform specific actions. This interaction requires the submission of necessary parameters or information to complete a query or interaction (addition, modification, subtraction) with the dynamic content. This information may need to be submitted in multiple steps. Once the submission of information is finished, the results of the interaction/query/e-commerce are sent back to the user.

Each time a user wishes to interact in the foregoing manner, the user is required to carry out each and every one of the steps associated with the submission of necessary parameters or information. If a same type of transaction is to be carried out in a repeated manner, this may be very time consuming and problematic.

Accordingly, accessing web content is more complicated than simply making individual HTTP requests. The prior art has yet to enable fetching of the same content as the user and rendering it the same way the user saw it. To do this, the appropriate content must first be fetched across the network. It must then be rendered correctly.

When fetching the content, the user may first be required to log in or run a search for a certain term. More generally, the content of interest could be generated by an arbitrary web transaction. Logging in and running a search are all examples of web transactions. Thus, fetching content requires support for various authentication and network protocols, management of client-side state information as well as support for the appropriate cipher strength.

It should be noted that fetching any interactive web content requires the ability to be able to execute web transactions. In the case of non-interactive content (e.g. the top headlines from a news site), no transaction is required to retrieve the content. One simply has to request the page from the remote server. However, if any interaction is required to access that content (e.g. weather report for a particular zip code), the transaction must be executed before the content can be retrieved.

Web transactions vary in their complexity. They may be as simple as entering a zip code to receive a customized weather report. On the other hand, they may be complex enough to involve logging in to a secure stock trading site, browsing to a particular page on the site, submitting a query and then browsing to a specific section in the report to obtain the current credit rating of a company.

Rendering the content is also a challenging problem. To start with, there is no well-defined standard for how web pages should display. Identical HTML is often rendered differently by competing browsers. Secondly, even apart from standards disputes and ambiguities, one can never be entirely sure that one has rendered a page as intended by the page designer. The designer may not have intended it for display on certain resolutions. Furthermore, not all browsers and clients are equally capable.

The aforementioned problems are compounded when attempting to access and navigate websites using wireless devices. Most websites are not wireless enabled. Nor can most wireless devices access and retrieve content from the websites directly.

There is therefore a need for wireless enablement of any website to allow output of desired content on a wireless device in a format amenable to display on the wireless device. There is also a need for a method to render active content into a format amenable to display on a device that does not support active content. There is also a need for a way to split content across multiple pages for output on a device of limited screen size and/or memory.

### SUMMARY OF THE INVENTION

A system, method and computer program product are provided for rendering arbitrary content for display on a particular viewing device. First, content is received. The content is assembled into an object-oriented structure in a centralized format. The content in the centralized format is translated to a markup language compatible with a display environment of a viewing device to create a markup language document. Preferably, the markup language is not manipulated, but rather a document constructed in accordance with the rules of that markup language is manipulated. This can mean, for example, that the content is translated into HTML or other format that the browser on the viewing device can read. The markup language document is formatted for display on the viewing device. This refers to the way the content is presented. A descriptor defines parameters of the display environment. The markup language document is formatted for display on the viewing device utilizing the descriptor. The formatted markup language document is output to the viewing device, which can be an electronic device of any sort including a wireless device, such as a wireless telephone, Personal Digital Assistant (PDA), handheld computer such as a handheld PC, a pager, a device connected to a wireless modem, or any type of device capable of receiving information where at least one of the communication links is wireless.

In one aspect of the present invention, the object-oriented structure is a tree-type structure, such as a Document Object Model (DOM) tree where each content element is a node in the tree and has child and parent nodes. A text string can be represented as a special kind of node called a Text Node. As one option, the content can be assembled into the object-oriented structure node by node. As another option, content that is already assembled into a string is parsed for translating the content into the centralized format. The translated content is then assembled into the object-oriented structure. As a further option, content written in the markup language is received and output to the viewing device without further processing.

In another aspect of the present invention, the centralized format is an XML format. In a further aspect of the present invention, the content in the markup language document is translated to a desired language and/or character set. This language or character set may be a particular user's native tongue.

In one aspect of the present invention, the formatting of the markup language document for display on the viewing device is based at least in part on a display screen size of the viewing device. Preferably, the formatting of the markup language document for display on the viewing device includes parsing a table into a format that is viewable (i.e., that fits) on a display of the viewing device.

In another aspect of the present invention, the formatting of the markup language document for display on the viewing device includes splitting the markup language document into multiple pages for display on the viewing device. This provides a mechanism for displaying content that would otherwise not fit on the display of the viewing device and/or that would not fit in the buffer (memory) of the viewing device. In yet another aspect of the present invention, the formatting of the markup language document for display on the viewing device includes inserting content in a template.

A system, method and computer program product are also provided for rendering arbitrary content for display on a particular viewing device: Content is received and assembled into a Document Object Model (DOM) tree in a centralized format. The content in the DOM tree is translated to a markup language compatible with a display environment of a viewing device. The markup language document is formatted for display on the viewing device. Such formatting includes splitting the markup language document into multiple pages for display on the viewing device. The formatted markup language document is output to the viewing device.

In one aspect of the present invention, the content is assembled into the DOM tree node by node. Content that is already assembled into a string can be parsed for translating the content into the centralized format, wherein the translated content is assembled into the DOM tree. As an option, content written in the target markup language is received and output to the viewing device without further processing (known as pass-through). Preferably, the centralized format is an XML format.

In another aspect of the present invention, a descriptor defines parameters of the display environment. The markup language document is formatted for display on the viewing device utilizing the descriptor. In a further aspect of the present invention, the content in the markup language document is translated to a desired language and/or character set. This language or character set may be a particular user's native tongue.

Preferably, the splitting of the markup language document is based at least in part on a display screen size of the viewing device. Alternatively or in addition to the screen size parameters, splitting of the markup language document can be based at least in part on a memory of the viewing device.

In a further aspect of the present invention, formatting of the markup language document for display on the viewing device includes parsing a table into a format that is viewable (i.e., that fits) on a display of the viewing device. In yet another aspect of the present invention, formatting of the markup language document for display on the viewing device includes inserting content in a template.

A system, method and computer program product are also provided for dividing content into multiple pages for display on a particular viewing device. Content is received and translated to a markup language compatible with a display environment of a viewing device. The markup language document is split into multiple items. The multiple items are parsed into multiple pages. Some pages may have multiple items on them, while others may have a single item or portion of an item on them. The result is a collection of pages that include all information found in the original content. One page of the set of pages is output to the viewing device. The one page has a pointer (preferably a URI) to at least one of the other pages. Such pointers allow a user to navigate to the other pages.

In one aspect of the present invention, each item is placed on a separate page. Preferably, each of the pages includes a header. Also preferably, an item is split across multiple pages if the item is too large for at least one of a memory (buffer) of the viewing device and a display screen size of the viewing device. Ideally, a split is made within contents of an XML tag. The tag itself is never split. The tag is placed on each of the multiple pages across which its contents are being split. Also preferably, words are not split. Rather, the split is made on a word break.

In another aspect of the present invention, selected portions of the content such as a header or HTML tag are used to organize the pages. Preferably, pages not being output to the viewing device are stored in a cache. Ideally, the cached pages are deleted upon closing of a session.

### BRIEF DESCRIPTION OF THE DRAWINGS

FIG. 1 illustrates a typical hardware configuration of a workstation in accordance with a preferred embodiment;

FIG. 2 illustrates a data flow through modules for a request coming from a display device according to a simplified embodiment of the present invention;

FIG. 3 is a flow diagram of a process for rendering arbitrary content for display on a particular viewing device according to another embodiment of the present invention;

FIG. 4 is a flowchart of the TRE process for rendering arbitrary content for display on a particular viewing device according to a preferred embodiment of the present invention; and

FIG. 5 is a flow diagram illustrating a process for dividing content into multiple pages for display on a particular viewing device according to an embodiment of the present invention.

### DESCRIPTION OF THE PREFERRED EMBODIMENTS

Glossary

Action An event which can be executed by the user or by script to change the state of the remote application (thus changing the state of the local application). For example, clicking a link.

content Any HTML content. Also includes a sub-tree of a full DOM tree.

custom (local) application An application created utilizing the platform

DOM Document Object Model, a W3C standard for describing XML documents in an object-oriented fashion. More particularly, it is a standard for representing an XML-compliant document in a tree format. Each element is a node in the tree and has child and parent nodes. A text string can be represented as a special kind of node called a Text Node.

DTD Document Type Definition, a document used to define an XML markup language. It contains the rules by which an XML Document of the corresponding markup language is constructed/validated.

element An XML element. Everything from <tag>to </tag>

markup language An XML Schema or DTD, which defines certain grammatical rules for how to construct or validate an XML document that can be set to be “of” the markup language, or “compliant with” or “formatted according to” or “an instance of” the markup language.

variable Represents a value which the designer's scripting code can manipulate. Variables can be one of the following three scope types: User, Session, or Application. And the Variable's underlying value can be one of three value types: (1) Primitive (not strongly-typed) (e.g. int, string, boolean), (2) Record (which is like a struct), and (3) Table (a list of records).

web content See content.

XHTML Extensible HyperText Markup Language, an XML-compliant version of HTML. XHTML is viewable on major browsers.

XML Extensible Markup Language, a syntax for creating SGML-compliant markup documents. The rules by which a document is constructed/validated can be specified via a DTD or XML Schema. XHTML is an example of an XML compliant markup language. XML documents may also be created which do not correspond to an explicitly defined schema. Such documents are said to be well-formed if they conform to the syntactical rules of XML, but their overall structure can be arbitrary.

XML Schema Update to DTDs, the preferred syntax for specifying the rules for constructing/validating documents of a particular markup language. XML Schema is itself an XML compliant markup language, unlike DTD's which use a weird non-XML syntax.

Illustrative System Architecture

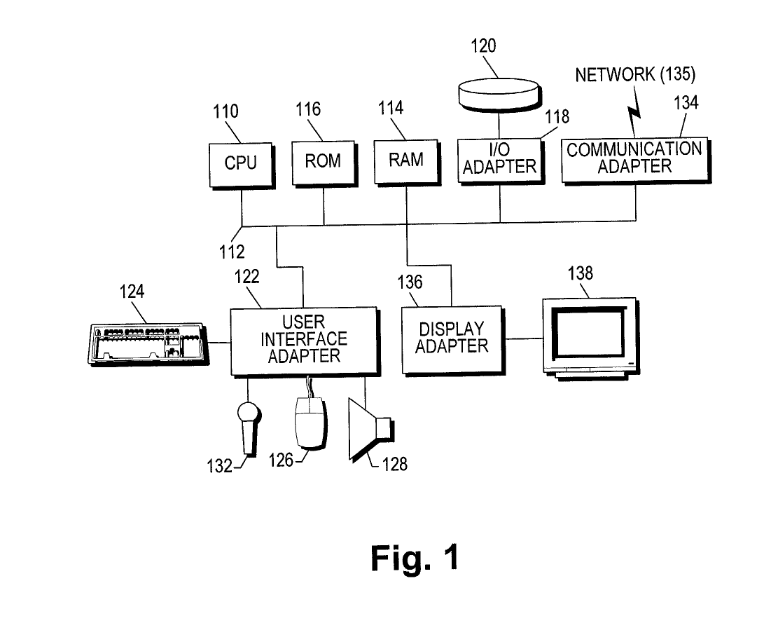

FIG. 1 illustrates a typical hardware configuration of a workstation in accordance with a preferred embodiment having a central processing unit 110, such as a microprocessor, and a number of other units interconnected via a system bus 112.

The workstation shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 328, a microphone 132, and/or other user interface devices such as a touch screen (not shown) to the bus 112, communication adapter 134 for connecting the workstation to a communication network 135 (e.g., a data processing network) and a display adapter 136 for connecting the bus 112 to a display device 138.

The workstation typically has resident thereon an operating system such as the Microsoft Windows NT or Windows Operating System (OS), the IBM OS/2 operating system, the MAC OS, or UNIX operating system. Those skilled in the art may appreciate that the present invention may also be implemented on platforms and operating systems other than those mentioned.

Transcoding Page Rendering Engine (TRE)

The Transcoding Page Rendering Engine (TRE), or transcoder, is a tool used to render content on any display environment.

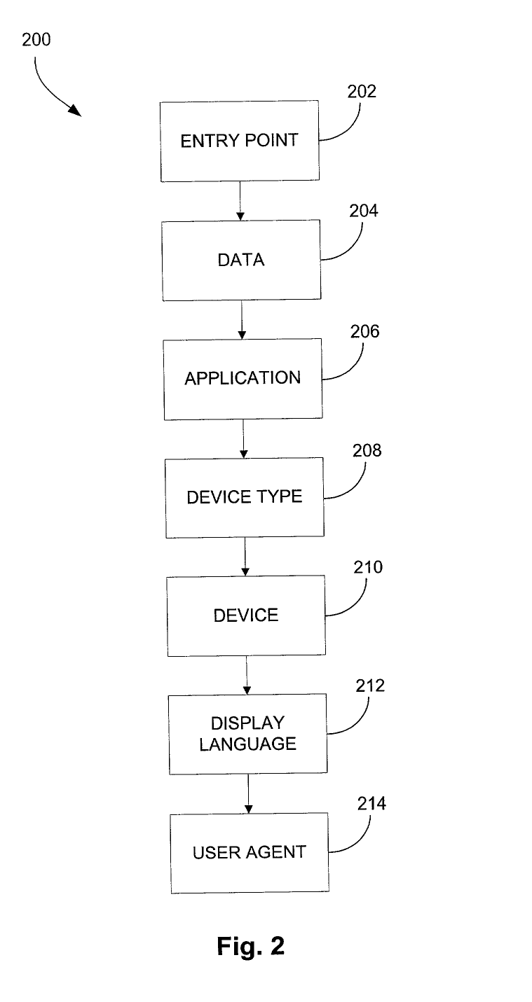

FIG. 2 illustrates a data flow 200 through modules for a request coming from a display device according to a simplified embodiment of the present invention. Note that FIG. 2 is only one particular way in which the TRE might be used.

The entry point module 202 authenticates and parses the request, and gathers all the necessary parameters about the device, user agent (browser), etc.

There are two primary interfaces into the transcoder:

1. ClickmarksXHTML (CXHTML)

2. Application Layout Schema

The former is discussed below as the input language used to describe the document that is to be transcoded. CXHTML is an extension of XHTML (Extensible Hypertext Markup Language). More information on CXHTML can be obtained from Clickmarks.com, Inc., 40983 Encyclopedia Circle, Fremont, Calif. 94538. Note that any other suitable input language can be used, such as XHTML or another variation thereof.

The Application Layout is a higher-level description of the output to be produced, and can include references to Java classes that are to be used for generating the CXHTML that will be fed into the transcoder. The Application Layout may also include different definitions of the output for different target devices (using Descriptors). Finally, the Application Layout may include references to variables. These references are resolved just prior to constructing the final output, thus allowing the application to dynamically insert mark-up into the final output. The Application Layout Schema can be provided as an XML Schema, which can be extended by the application to define new types of UI objects and the corresponding classes that should be used to render those objects.

The Transcoder provides a layout compiler function, which takes as input an Application Layout document, and produces a sequence of CXHTML documents one for each target device referenced in the Application Layout document (via Descriptors). When the output is to be displayed to the device, the Transcoder selects the XHTML document appropriate for the current device, substitutes any variable references using an application supplied variable resolver, and then transcode the result to the format required by the target device. This is another way in which the transcoder can be used.

With continued reference to FIG. 2, the data module 204 fetches the requested data and invokes the application module to display it.

The application module 206 is invoked for each container and piece of data that needs to be displayed as part of the request. The application module generates a display-independent XML representation of the content, using an XML markup language defined by Clickmarks, called Clickmarks XHTML.

For each content type defined in the application, there is a corresponding class, which includes a “render” method. This method encapsulates how to display an object of this type using Clickmarks XHTML.

The primitive data types (e.g. link, image, etc.) are covered by platform provided classes. However, the application developer may define new types of objects by providing new classes to further customize the behavior of the application. The “render” method produces a fragment of Clickmarks XHTML which is then transcoded to the target language in the subsequent steps. The XHTML fragment conforms to an extended version of the XHTML Basic Module (as defined by the W3C at: http://www.w3.org/TR/xhtml-basic/). Preferably the application classes are written in the Java programming language, but they can also be written in other languages such as Perl, C++, or any other programming language.

### EXAMPLE

This example describes the flow for a custom application data type called “Weather”.

Step 1: Request

The request is for a “Page” container with id=1. The “page” class is loaded, and the “render” method is invoked to display the container.

Step 2: Weather

The container contains a single content item of type “Weather”. The “weather” class is loaded, and the “render” method is invoked to display the content item.

Step 3: Display

The weather class's render method is a custom method implemented by the application designer. It formats the weather data stored in the database into a small XHTML table. It then invokes the “displayXHTML” method on the transcoder.

Step 4: Transcoding

The XHTML fragment is inserted into the display-independent output document. As this document proceeds through the TRE, the fragment is transcoded into the final display language.

Referring again to FIG. 2, the Device Type module 208 adjusts the display-independent document based on the type of the requesting device. Only gross adjustments are made based on the broad characteristics of the device. For example, if the device is a PDA then certain containers may be “inlined” meaning that the container's content is displayed directly within the parent. If on the other hand the device is a small-screen telephone, then this module strives to turn most of the containers into links, so that only the top-most container is displayed on the screen. If this device is of type “Audio” then all references to images are replaced with textual descriptions of the image if available.

The Device module 210 adjusts the document based on the specific properties of the device. For example, if this is a Palm device with a limited set of supported fonts, references to fonts etc. are normalized to the font-set supported by the device.

By way of another example, if the requesting device is a phone that imposes a certain size limitation on the amount of data sent to it, the document is adjusted to reduce the amount of data. This may include replacing redundant information with references to variables, etc.

The Display Language module 212 transforms the document into a display language specific document. For example, if the target display language is HTML 3.2, then the document is transformed into an HTML 3.2 document. At this point the transformation is still generic, that is, it does not account for differences in the browser implementations. This document may not yet conform to the display language schema. In other words, it may contain additional elements and attributes to aid in the final steps below.

The User Agent module 214 adjusts the language specific document to account for the vagaries of User Agent implementations. For example, if this is a WML document to be displayed on a phone.com browser, all the links are displayed as “choice” elements rather than anchor elements to provide short-cut keys for following those links.

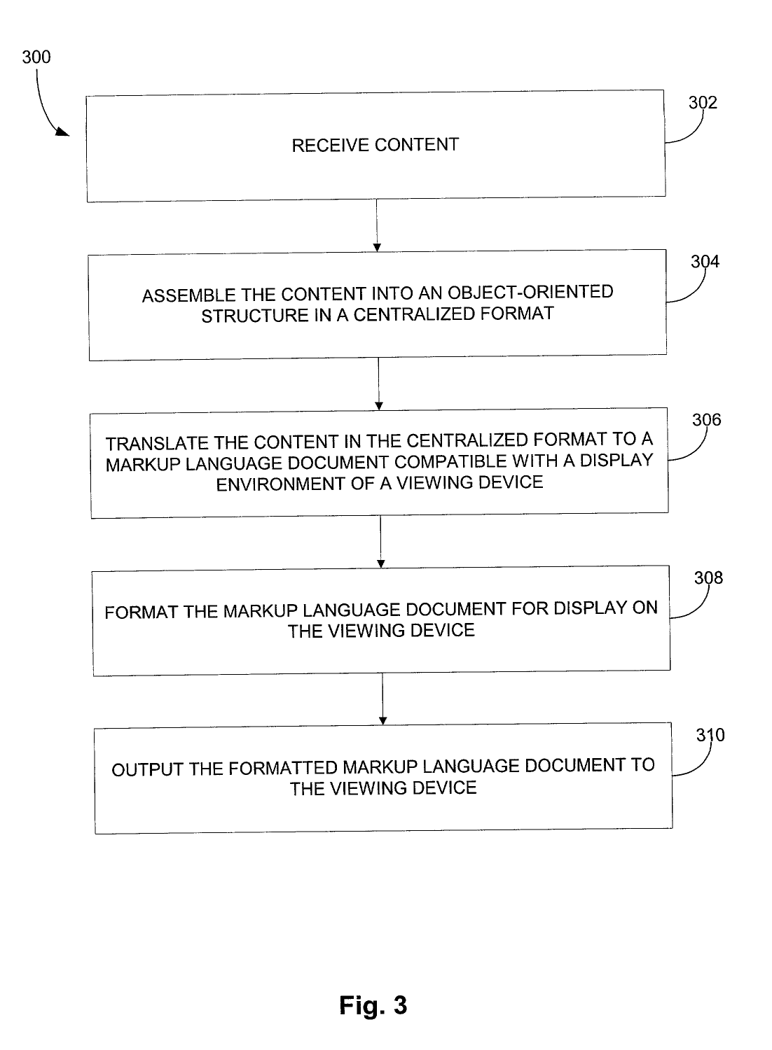

FIG. 3 is a flow diagram of a process 300 for rendering arbitrary content for display on a particular viewing device according to another embodiment of the present invention. In operation 302, content is received. In operation 304, the content is assembled into an object-oriented structure in a centralized format. The content in the centralized format is translated to a markup language compatible with a display environment of a viewing device in operation 306 to create a markup language document. Preferably, the markup language is not manipulated, but rather a document constructed in accordance with the rules of that markup language is manipulated. This can mean, for example, that the content is translated into HTML or other format that the browser on the viewing device can read. The markup language document is formatted for display on the viewing device in operation 308. This refers to the way the content is presented. Preferably, a descriptor that defines parameters of the display environment is used to format the markup language document for display on the viewing device. In operation 310, the formatted markup language document is output to the viewing device, which can be an electronic device of any sort including a wireless device, such as a wireless telephone, Personal Digital Assistant (PDA), handheld computer such as a handheld PC, a pager, a device connected to a wireless modem, or any type of device capable of receiving information where at least one of the communication links is wireless.

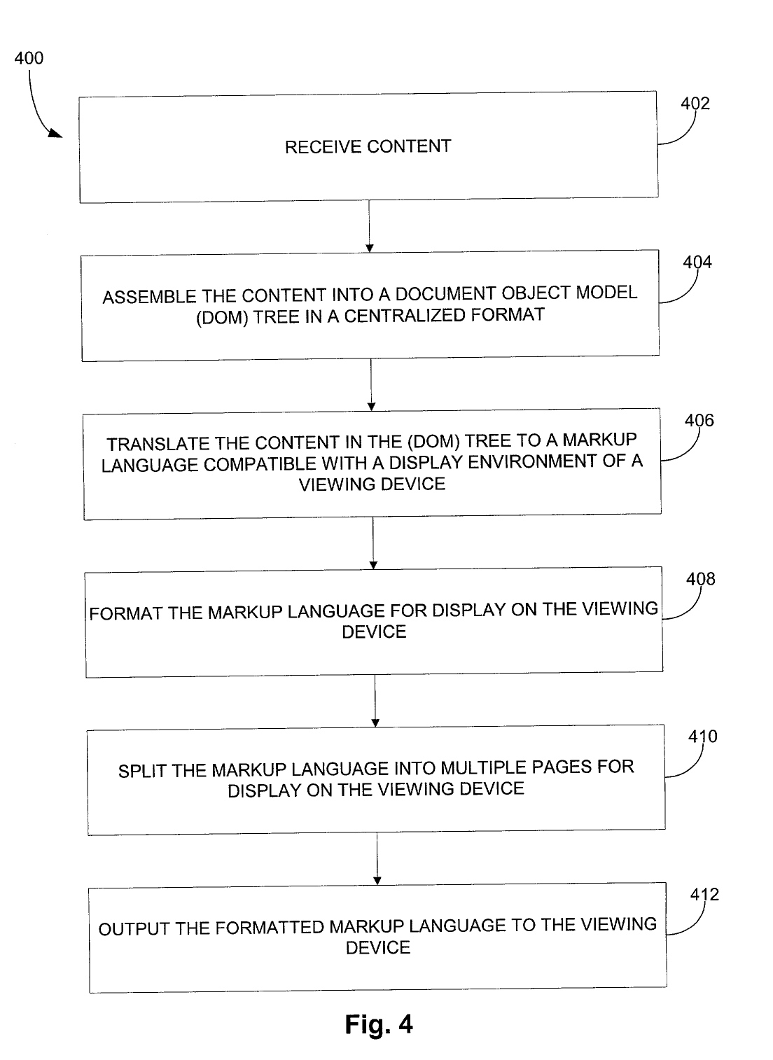

FIG. 4 is a flowchart of the TRE process 400 for rendering arbitrary content for display on a particular viewing device according to a preferred embodiment of the present invention. In operation 402, content is received. In operation 404, the content is built into a DOM tree in an extended version of XHTML, referred to herein as CXHTML. This DOM tree is then processed in operation 406 by several modules which translate the CXHTML into an appropriate markup language for the viewing environment and format this markup language to display best on the viewing device in operation 408, which may include splitting the final document into multiple pages. Note operation 410. The markup language representation of the content can also be translated into the user's native language and/or character set. In operation 412, the content is output to the viewing device.

There are six module classes described herein, and more may be added as necessary. In addition, new modules may be added at any time to these module classes. These modules can be executed in the following order:

1. Device Type

2. Device

3. Markup Language

4. Human Language

5. User Agent)

6. Character Set

The TRE provides tools to build up the final document in three ways. The first method is assembling a CXHTML document node-by-node. If the application has the desired pieces of content already assembled into a string, such as when a web page is dragged in directly from the Internet, parsing tools are provided to translate the web page into a CXHTML document. Finally, for maximum control, content may be written directly to the target markup language and passed through the first three modules unchanged. Content written directly in the target markup language can also be passed to the viewing device without further processing (referred to as pass-through markup).

A Descriptor class is defined, which encapsulates the parameters of the viewing environment. More particularly, the descriptor defines parameters of the display environment. The final output document is formatted for display on the viewing device using the descriptor.

Functionality

The TRE, according to a preferred embodiment, is made up of one main class (the transcoder), the Descriptor class and (preferably) six sets of environment module classes. The main class calls one module class from each category, according to the device, and executes them in the pre-defined order.

Each of these module classes inherits from a module superclass. There is one superclass per module type, which defines the default behavior of a module type as well as tools that may be useful for modules inheriting from the superclass.

The Transcoder object contains a set of tools used to build up the complete page that is to be rendered. Once this page has been assembled, this object initiates the multi-module transcoding process.

There are three major ways in which the transcoder can convert and add a piece of content to the page. (In this explanation, the total content to be transcoded is referred to as the “page;” an individual component of that page, i.e., the “content;” and the process of converting the piece of content to our internal format as “rendering.”)

The conversion process can be described by way of an example in which a page contains several news headlines. Each headline is a piece of content. In the first case, the headline is simply a piece of HTML imported directly from the web. This piece can then be parsed and appended to the main page. In the second case, an HTML headline is written directly from the application code. The tools to do this are also provided. In both these cases, the transcoder handles all translation to the final markup language. In the third case, specific control over how the headline is rendered is provided in each target markup language. This allows creation of “passthrough” markup which is not rendered by the transcoder, but passed-through into the final document; hence the name “passthrough.”.

The Descriptor is preferably a wrapper around a set of parameters that describes the viewing event and identifies the module to use. Each parameter type is identified by an ID number. Using this ID number the parameter's integer value or name can be obtained. The Transcoder uses the Descriptor to determine how to format the content. The Descriptor can also be used to define the way content is displayed. For example, the Descriptor can instruct the Transcoder to send an entire stock name (e.g., Intel) to a desktop, and only the symbol (e.g., INTC) to a phone.

CXHTML

CXHTML is the internal format in which content is manipulated. It is an extended version of XHTML. Several XHTML extensions are provided below.

<Back>

The Back tag is a sample link (template) which is used by the Markup Language module to create links that point (back) to a previously-cached section of the page if the page is split into smaller pieces. The User Agent module uses this tag to create “back” buttons in the final markup.

<Header>

The header tag is used by the Markup Language Module to encapsulate all markup that is to be placed at the top of any markup (i.e. <HTML><BODY>). It is assumed that the lowest-level element in the header contents will be the one to which the final content is attached (this will occur in the user agent). The header contains markup that is replicated at the top of each sub-page during page splitting.

<Content>

The Content tag surrounds each individual content item within the document.

<Container>

The Container tag surrounds each individual container item within the document.

<More>

The More tag is a sample link (template) used by the Markup Language module to create a link that points to a cached section of the content page if the page is to be split into smaller pieces. The User Agent module uses this tag to create “more” buttons in the final markup.

<Pagebreak>

Attributes: Items, Bytes

This denotes a split between pages. There should be only one Pagebreak element per document. The Items attribute specifies the maximum number of items that should be displayed on a page. The Bytes attribute specifies the maximum number of bytes that should be displayed on a page. Note that the Markup Language module uses this as a guideline to splitting up the content tree for display-however, the atomicity of an item will be maintained rather than filling a screen to its maximum Item or Byte length.

<Passthrough>

This is a placeholder to store any pass-through markup. The markup code should be contained within the Passthrough tags of the given parameter in the (human) language specified.

Device Types

The device type module is responsible for all processing that is specific to a particular device type, such as Palm IV c. Palm V. Table 1 lists several modules that can be included in the TRE.

TABLE 1

| Module | Description | Code |
|---|---|---|
| PDA | e.g. Palm, Pocket PC | T1 |
| Web Phone | e.g. Nokia 7110, iMode, etc. | T2 |
| Audio | e.g. VoiceXML browser. | T3 |
| Screen Phone | e.g. Nokia 9000, etc. | T4 |
| PC | e.g. Windows desktop, Macintosh, etc. | T5 |
| Pager | e.g. Blackberry, PageWriter, etc. | T6 |

Illustrative processing performed by the device types module includes:

Screen Sizing

The screen size of all devices within a device type should be similar, so the first responsibility of the device type module is to set an appropriate screen size using the <Pagebreak> tag.

Table Rendering

Tables produce a complicated rendering task on smaller-screened devices, so the device type module is responsible for parsing a table into a format that is viewable on the given device type. Note: the reformatted table still conforms to CXHTML markup.

The device types module analyzes a table and determines how many cells per line will fit on the display of the device. Then it pulls the table apart and reformats it cell by cell so that it will fit into the display.

The device types module can reformat virtually the entire table including headers so that the table makes sense as displayed. For example, take a table that has a stock ticker. The table in its original form includes in its first row IBM, last trading price, and volume. The second row has Intel, last trading price, and volume. The table in its original form dies fit on a phone display. The table rendering module breaks the table down so IBM, its price, and volume are displayed in one column on one screen of the phone, while Intel, its price, and volume are shown on the next page displayed.

More information on table rendering can be found in Provisional US Patent Application entitled SYSTEM, METHOD AND COMPUTER PROGRAM PRODUCT FOR TRANSCODING TABULAR CONTENT FOR DISPLAY ON THIN CLIENT DEVICES BY WAY OF CONTENT ADDRESSING filed Apr. 12, 2001 under serial No. 60/283,804, and which is herein incorporated by reference in its entirety.

Scripts

Scripting is not available on many device types, so the device types module may need to intercept any scripting tags (i.e. <Applet>, <Script>) and remove these tags and their contents if the device type cannot handle that type of script.

Devices

The device module is responsible for tweaking the changes made by the device type module for the specifics of a certain device. Screen sizing is the most affected.

Table 2 lists several modules that can be included in the TRE.

TABLE 2

| Module | Description | Code |
|---|---|---|
| Palm III, V, Vx | Gray-scale, pen, dis-connected. | D1 |
| Palm VII | Gray-scale, pen, connected | D2 |
| Palm IIIc | Color!, pen, dis-connected | D3 |
| Pocket PC | Color, pen, dis-connected | D4 |
| Nokia 7110 | Nokia WAP phone | D5 |
| Ericcson | Ericcson WAP phone | D6 |
| Motorola V2282 | Motorola WAP phone | D7 |
| Phone.com HDML | HDML phones (Qualcomm and Samsung) | D8 |
| VoiceXML Device | Voice Server | D9 |
| Desktop | Windows desktop | D10 |
| RIM | RIM pager | D11 |
| Motorola PageWriter | PageWriter 2-way pager | D12 |

Markup Languages

The markup language module is responsible for translating the CXHTML document to a document of the appropriate markup that is readable by the device. It contains a mapping from each XHTML element to the appropriate element or combination of elements in the target markup language. It also takes the contents of any <Passthrough> tags and appends their contents unchanged to the new document. <Content>, <Container> and <Pagebreak> tags are transferred unchanged to the target document as these are used by later modules.

The <Header> tag is populated with that markup header information that is in every page (i.e. <HTML><BODY> for HTML). All further content that is displayed on a particular page is appended to the deepest child node of the header (in this example it is appended to <BODY>).

A <More> tag is also produced and attached to the document root. This tag contains a template for rendering a link to the next sub-page, in the given markup language.

The list presents several exemplary markup languages that can be supported by the present invention. Note that this list is not exhaustive.

1. Text (pagers, SMS, etc.)

2. HTML 3.2 (several flavors, including i-mode, Palm VII, AvantGo, etc.).

3. CHTML (I-Mode)

4. XHTML.

5. HDML

6. WML

7. VoiceXML

8. XML (raw data format for doing data exchange).

Table 3 lists several modules that can be included in the transcoder.

TABLE 3

| Module | Description | Code |
|---|---|---|
| HTML 2.0 | Primarily for iMode phones | L1 |
| HTML 3.2 | For Palm, Pocket PC | L2 |
| HTML 4.0 | For Desktops | L3 |
| XHTML 1.0 | For Desktops | L4 |
| HDML 3.2 | For HDML phones. | L5 |
| WML 1.1 | For WAP phones, pagers, PDA's | L6 |
| WML 1.2 | Future! | L7 |
| VoiceXML 1.0 | Audio devices | L8 |
| Text | For pagers. | L10 |

Human Languages

The human languages module is responsible for translating content into a desired language. Human languages can be supported by an internal translation program, or by an external translation package such as the Lernout & Hauspie iTranslator. Tag names are not affected, but all text within a tag is translated, unless that tag contains a script.

User Agents

The user agent module is responsible for formatting for the particular browser being used on the device. For example, it reformats the final output depending on whether the device is running Microsoft Internet Explorer or Netscape Navigator. Functions of the user agent module include page splitting, creating templates, and any small tweaks to the markup code that need to be made for that particular agent.

Table 4 lists several user agent modules that can be included in the transcoder.

TABLE 4

| Module | Description | Code |
|---|---|---|
| IModeHTML | HTML 2.0 for iMode phones | U1 |
| AvantGoHTML | HTML 3.2 for PDA's | U2 |
| YadaYadaHTML | HTML 3.2 for PDA's | U3 |
| WebClippingHTML | HTML 3.2 for Palm VII | U4 |
| IE (different versions?) | Internet Explorer for Desktop, | U5 |
| | PDA's | |
| Netscape (different versions?) | Netscape for Desktops | U6 |
| Phone.comHDML | HDML for US WAP phones | U7 |
| Phone.comWML | WML for WAP phones | U8 |
| NokiaWML | WML for Nokia phones | U9 |
| EricssonWML | WML for Ericsson phones | U10 |
| IBMVoiceXML | IBM's VoiceXML browser | U11 |
| NuanceVoiceXML | Nuance's VoiceXML browser | U12 |
| RIMText | RIM email client | U13 |
| MotorolaText | PageWriter email client | U14 |

Page (Deck) Splitting

In order to avoid overrunning a device's buffer, large markup documents may have to be split into multiple pages. The user agent module is responsible for splitting large documents into multiple pages.

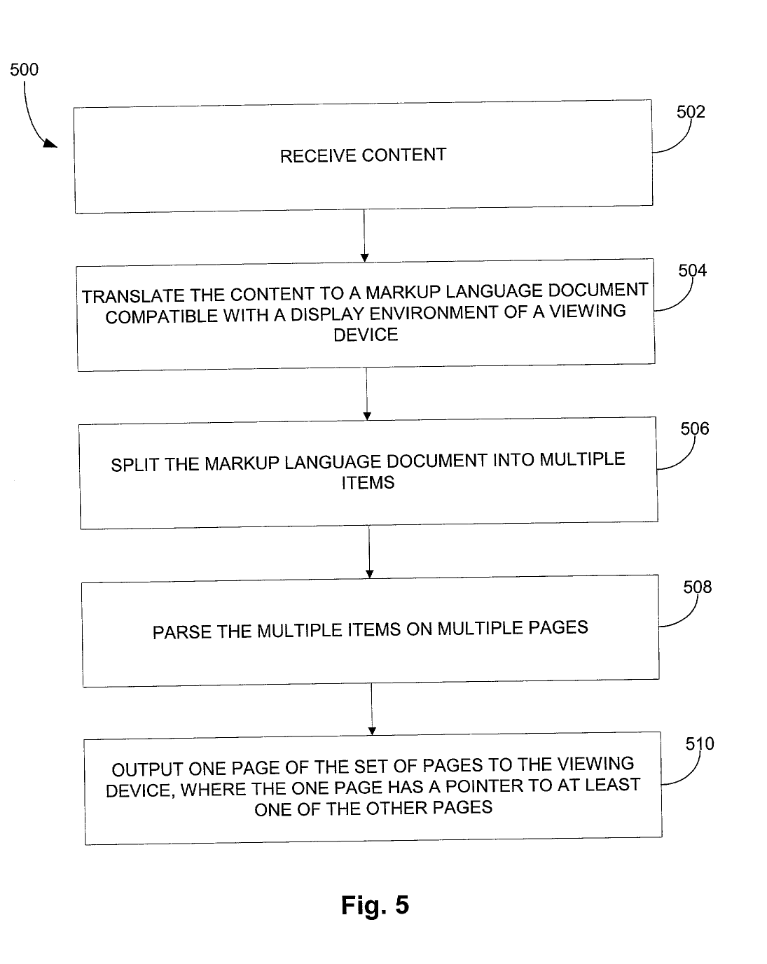

FIG. 5 is a flow diagram illustrating a process 500 for dividing content into multiple pages for display on a particular viewing device according to an embodiment of the present invention. Content is received in operation 502 and is translated to a markup language document compatible with a display environment of a viewing device in operation 504. The document is split into multiple items in operation 506. In operation 508, the multiple items are split accross multiple pages. Some pages may have multiple items on them, while others may have a single item or portion of an item on them. The result is a collection of pages that include all information found in the original content. In operation 510, one page of the set of pages is output to the viewing device. The one page has a pointer (URL) to at least one of the other pages. Such pointers allow a user to navigate to the other pages.

Each item can be placed on a separate page and/or can be appended to other pages. An item can be split across multiple pages if the item is too large for either the memory (buffer) or display screen size of the viewing device.

According to a preferred embodiment, items are kept atomic. In other words, no item is broken up across multiple pages unless the item is too big to be displayed on a single page by itself. This module handles and removes <Pagebreak> and <Item> tags, and creates several DOM trees based on these breaks. Each DOM tree includes the contents of the <Header> tag.

The page is first split into several “items”, as well as a “header” and a template “more” and “back” link. Each new page contains a copy of the header, as well as a more link (unless this is the last page in the series) and a back link (unless this is the first page in the series). For example, at the end of every page, a “more” button can be inserted using the template provided in the <More> tag. The last page does not have a “more” tag.

Each item is measured and appended to the first page if there is room. If there is not room, then another page is created as described above, and the item is appended to the new page. This happens until all items have been placed on a page, resulting in a collection of pages that contain all information available in the original page, still in valid markup.

In the event that a single item is too big to fit into its own page, it needs to be split up in a way that makes sense visually, and loses as little information as possible. The following rules can be used to accomplish this:

Tags are atomic—that is, the tag itself cannot be split (i.e. <gregtag> cannot be split like <gre|gtag>)

If a split is made within the contents of a tag, then that tag must be on both pages, and a parent of all split information that came from within. For example <b> here is some text</b> would split to: <b> here is </b>|<b> some text</b>

If a split is made within a text node, it should occur on a space; no words should be split.

Portions of the pages can be used to organize the new pages. Headers and HTML tags are examples of items that can be used to organize the pages. For example, all pages having the same header or tag can be grouped together in the order in which the original content appears in the original markup.

The first DOM tree is passed on to the next module and processed normally. All other DOM trees are stored in the file system (cached) with a naming convention such as /session_id/cache_id.html. Caching the pages conserves system resources in that the markup does not need to be split and new pages generated each time a new page is uploaded to the viewing device. Each of these stored files has a unique id within the current session. Each “more” tag within a split deck points to this URL containing the next page in the deck. This URL can be of the form http://host/session_id/cache_id.html, for example. The cache is good as long as the session is valid; when the session is closed or expired, all cached material for that session will be removed.

Templates

Some viewing environments, such as a desktop computer running Netscape are capable of providing more complex environments. For this reason, templates are allowed to be placed around the content created by the TRE. Templates allow a user to add content that appears on each page displayed on the viewing device. For example, a template of a company logo with sections where varying content can be entered can be created. Each page displayed on the viewing device would then have the company logo on it in a position defined in the template. Other, varying content would then be displayed in the portions of the template reserved for such content.

The template does not vary from one viewing environment to the next, and is associated with a specific user agent. One type of template is a template written in CXHML, which is converted into the target markup language. Another type is a pass-through type template, which is written directly in the target markup language.

Character Set

Many human languages must be rendered in a character set other than ASCII. The character set module is responsible for determining which character set is required. If that character set is not supported on the device in question, such as Chinese characters on a wireless phone, then the character set can be rendered using Wordwalla technology. This technology draws graphics of the target characters and renders them for display on the device.

Extensibility

The sequence described above can be changed arbitrarily. This flexibility is accomplished by having a Central Arbiter (CA) that shepherds the document through the different stages. At each stage, the module returns a completed document when finished. The CA then determines what module to invoke next, and passes it the document and the request parameters. When the final module has been invoked, the resulting document is returned to the requesting device.

The application can define new modules and insert them into the pathway anywhere along the chain. However, care should be taken that the module produces the right kind of document expected by the next module in the sequence.

In addition, any of the modules described above can be extended by the application to add custom behavior to the system. The application would define a new module that inherits from the platform provided one. Any of the module's public methods can be overridden to change the behavior of the module. The overridden method can still invoke the original method in the parent class, and then make changes to the result.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for rendering arbitrary content for display on a particular viewing device, comprising:
(a) receiving content;
(b) assembling the content into an object-oriented structure in a centralized format;
(c) translating the content in the centralized format to a markup language document compatible with a display environment of a viewing device;
(d) formatting the markup language document for display on the viewing device utilizing a descriptor, wherein the descriptor defines parameters of the display environment; and
(e) outputting the formatted markup language document to the viewing device.

2. The method as recited in claim 1, wherein the object-oriented structure is a tree-type structure.

3. The method as recited in claim 1, wherein the content is assembled into the object-oriented structure node by node.

4. The method as recited in claim 1, wherein content that is assembled into a string is parsed for translating the content into the centralized format, wherein the translated content is assembled into the object-oriented structure.

5. The method as recited in claim 1, further comprising receiving content written in the markup language, and outputting the content written in the markup language to the viewing device.

6. The method as recited in claim 1, wherein the centralized format is an XML format.

7. The method as recited in claim 1, further comprising translating the content to a desired language.

8. The method as recited in claim 1, further comprising translating the content to a desired character set.

9. The method as recited in claim 1, wherein the formatting of the markup language document for display on the viewing device is based at least in part on a display screen size of the viewing device.

10. The method as recited in claim 9, wherein the formatting of the markup language document for display on the viewing device includes parsing a table into a format that is viewable on a display of the viewing device.

11. The method as recited in claim 1, wherein the formatting of the markup language document for display on the viewing device includes splitting the markup language document into multiple pages for display on the viewing device.

12. The method as recited in claim 1, wherein the formatting of the markup language document for display on the viewing device includes inserting content in a template.

13. The method as recited in claim 1, wherein the display device is a wireless device.

14. A computer program product for rendering arbitrary content for display on a particular viewing device, comprising:
(a) computer code for receiving content;
(b) computer code for assembling the content into an object-oriented structure in a centralized format;
(c) computer code for translating the content in the centralized format to a markup language document compatible with a display environment of a viewing device;
(d) computer code for formatting the markup language document for display on the viewing device utilizing a descriptor, wherein the descriptor defines parameters of the display environment; and
(e) computer code for outputting the formatted markup language document to the viewing device.

15. A system for rendering arbitrary content for display on a particular viewing device, comprising:
(a) logic for receiving content;
(b) logic for assembling the content into an object-oriented structure in a centralized format;
(c) logic for translating the content in the centralized format to a markup language document compatible with a display environment of a viewing device;
(d) logic for formatting the markup language document for display on the viewing device utilizing a descriptor, wherein the descriptor defines parameters of the display environment; and
(e) logic for outputting the formatted markup language document to the viewing device.

16. A method for rendering arbitrary content for display on a particular viewing device, comprising:
(a) receiving content;
(b) assembling the content into a Document Object Model (DOM) tree in a centralized format;
(c) translating the content in the DOM tree to a markup language document compatible with a display environment of a viewing device;
(d) formatting the markup language document for display on the viewing device;
(e) splitting the markup language document into multiple pages for display on the viewing device; and
(f) outputting the formatted markup language document to the viewing device.

17. The method as recited in claim 16, wherein the content is assembled into the DOM tree node by node.

18. The method as recited in claim 16, wherein content that is assembled into a string is parsed for translating the content into the centralized format, wherein the translated content is assembled into the DOM tree.

19. The method as recited in claim 16, further comprising receiving content written in the markup language, and outputting the content written in the markup language to the viewing device.

20. The method as recited in claim 16, wherein the centralized format is an XML format.

21. The method as recited in claim 16, wherein a descriptor defines parameters of the display environment, wherein the markup language document is formatted for display on the viewing device utilizing the descriptor.

22. The method as recited in claim 16, further comprising translating the content to a desired language.

23. The method as recited in claim 16, further comprising translating the content to a desired character set.

24. The method as recited in claim 16, wherein the splitting of the markup language document is based at least in part on a display screen size of the viewing device.

25. The method as recited in claim 16, wherein splitting of the markup language document is based at least in part on a memory of the viewing device.

26. The method as recited in claim 16, wherein the formatting of the markup language document for display on the viewing device includes parsing a table into a format that is viewable on a display of the viewing device.

27. The method as recited in claim 16, wherein the formatting of the markup language document for display on the viewing device includes inserting content in a template.

28. The method as recited in claim 16, wherein the display device is a wireless device.

29. A computer program product for rendering arbitrary content for display on a particular viewing device, comprising:
(a) computer code for receiving content;
(b) computer code for assembling the content into a Document Object Model (DOM) tree in a centralized format;
(c) computer code for translating the content in the DOM tree to a markup language document compatible with a display environment of a viewing device;
(d) computer code for formatting the markup language document for display on the viewing device;
(e) computer code for splitting the markup language document into multiple pages for display on the viewing device; and
(f) computer code for outputting the formatted markup language document to the viewing device.

30. A system for rendering arbitrary content for display on a particular viewing device, comprising:
(a) logic for receiving content;
(b) logic for assembling the content into a Document Object Model (DOM) tree in a centralized format;
(c) logic for translating the content in the DOM tree to a markup language document compatible with a display environment of a viewing device;
(d) logic for formatting the markup language document for display on the viewing device;
(e) logic for splitting the markup language document into multiple pages for display on the viewing device; and
(f) logic for outputting the formatted markup language document to the viewing device.

31. A method for dividing content into multiple pages for display on a particular viewing device, comprising:
(a) receiving content;
(b) translating the content to a markup language document compatible with a display environment of a viewing device;
(c) splitting the markup language document into multiple items;
(d) parsing the multiple items on multiple pages;
(e) outputting one page of the set of pages to the viewing device, wherein the one page has a pointer to at least one of the other pages.

32. The method as recited in claim 31, wherein each item is placed on a separate page.

33. The method as recited in claim 31, wherein each of the pages includes a header.

34. The method as recited in claim 31, wherein an item is split across multiple pages if the item is too large for a memory of the viewing device.

35. The method as recited in claim 34, wherein a tag of the item is not split.

36. The method as recited in claim 34, wherein a split is made within contents of a tag, wherein the tag is placed on each of the multiple pages.

37. The method as recited in claim 31, wherein an item is split across multiple pages if the item is too large for a display screen size of the viewing device.

38. The method as recited in claim 37, wherein a tag of the item is not split.

39. The method as recited in claim 37, wherein a split is made within contents of a tag, wherein the tag is placed on each of the multiple pages.

40. The method as recited in claim 31, wherein words are not split.

41. The method as recited in claim 31, wherein selected portions of the content are used to organize the pages.

42. The method as recited in claim 31, wherein pages not being output to the viewing device are stored in a cache.

43. The method as recited in claim 42, wherein the cached pages are deleted upon closing of a session.

44. A computer program product for dividing content into multiple pages for display on a particular viewing device, comprising:
(a) computer code for receiving content;
(b) computer code for translating the content to a markup language document compatible with a display environment of a viewing device;
(c) computer code for splitting the markup language document into multiple items;
(d) computer code for parsing the multiple items on multiple pages;
(e) computer code for outputting one page of the set of pages to the viewing device, wherein the one page has a pointer to at least one of the other pages.

45. A system for dividing content into multiple pages for display on a particular viewing device, comprising:
(a) logic for receiving content;
(b) logic for translating the content to a markup language document compatible with a display environment of a viewing device;
(c) logic for splitting the markup language document into multiple items;
(d) logic for parsing the multiple items on multiple pages;
(e) logic for outputting one page of the set of pages to the viewing device, wherein the one page has a pointer to at least one of the other pages.

46. A method for rendering arbitrary content for display on a particular viewing device, comprising:
(a) receiving content;
(b) assembling the content into an object-oriented structure in a centralized format;
(c) translating the content in the centralized format to a markup language document compatible with a display environment of a viewing device;
(d) parsing a table into a format that is viewable on a display of the viewing device;
(e) splitting the markup language document into multiple pages for display on the viewing device;
(f) performing further formatting of the markup language document for display on the viewing device; and
(g) outputting the formatted markup language document to the viewing device.

47. A method for rendering arbitrary content for display on a particular wireless viewing device, comprising:
(a) receiving content;
(b) assembling the content into a Document Object Model (DOM) tree in a centralized format node by node, wherein content that is assembled into a string is parsed for translating the content into the centralized format;
(c) translating the content to a desired language;
(d) translating the content to a desired character set;
(e) translating the content in the DOM tree to a markup language document compatible with a display environment of a wireless viewing device;
(f) parsing a table into a format that is viewable on a display of the viewing device;
(g) splitting the markup language document into multiple pages for display on the viewing device;
(h) performing further formatting of the markup language document for display on the viewing device, wherein the descriptor defines parameters of the display environment;
(i) splitting the markup language document into multiple pages for display on the wireless viewing device, wherein the splitting of the markup language document is based at least in part on a display screen size of the viewing device and at least in part on a memory of the viewing device; and
(j) outputting the formatted markup language document to the wireless viewing device.

48. A method for dividing content into multiple pages for display on a particular viewing device, comprising:
(a) receiving content;
(b) translating the content to a markup language document compatible with a display environment of a viewing device;
(c) splitting the markup language document into multiple items;
(d) parsing the multiple items on multiple pages;
(e) splitting an item across multiple pages if the item is too large for a memory of the viewing device;
(f) splitting an item across multiple pages if the item is too large for a display screen size of the viewing device;
(g) making a split within contents of a tag, wherein the tag is placed on each of the multiple pages, wherein the tag itself is not split;
(h) using selected portions of the content to organize the pages;
(i) outputting one page of the set of pages to the viewing device, wherein the one page has a pointer to at least one of the other pages;
(j) storing pages not being output to the viewing device in a cache; and
(k) deleting the cached pages upon closing of a session.
